(19) United States
(12) Patent Application Publication
(10) Pub. No.: US 2010/0240007 A1
(43) Pub. Date: Sep. 23, 2010

(54) Dental Equipment Connection Joint

(76) Inventors: Joe Bria, Waxhaw, NC (US); Austin Unsworth, Fort Mill, SC (US)

Correspondence Address: Beusse Wolter Sanks Mora & Maire, 390 N. ORANGE AVENUE, SUITE 2500, ORLANDO, FL, 32801, US

(21) Appl. No.: 12/726,414

(22) Filed: Mar. 18, 2010

Related U.S. Application Data
(60) Provisional application No. 61/161,762, filed on Mar. 19, 2009.

(51) Int. Cl. A61C 3/00

(52) U.S. Cl. 433/147

(57) ABSTRACT

Disclosed herein is a dental equipment connection joint that enables the easy and efficient removal and securing of dental equipment to a support structure. The installer can readily and easily attach dental equipment, such as a dental light or dental instrument unit, to the dental equipment mount solely through the use of hand manipulation, without tools, according to a one-step operation. The dental equipment connection joint enables the replacement of potentially heavy dental equipment via a process that alleviates the need for the installer to bear the load of the equipment while installing a screw or similar fasteners.

### RELATED APPLICATIONS

This application claims priority to U.S. Ser. No. 61/161,762 filed Mar. 19, 2009, which is incorporated herein in its entirety.

### FIELD OF INVENTION

The inventions of this application relate to the field of dental equipment support structures and especially adapted detachable connection joints for holding dental equipment, such as dental examination lights or instrument delivery units, suspended from the ceiling of a dental office or from other overhead support structures.

### BACKGROUND

Dental operatories contain a number of dental equipment pieces that are used by the dental provider. These dental equipment pieces (e.g. dental examination lights, or dental work tables, and instrument units, e.g. dentist instrument unit, or assistant's instrument unit) are typically secured to the ceiling, walls or floor of the dental operatory, or to dental furniture in the operatory, by dental support members, such as brackets, poles, etc. Periodically, these dental equipment pieces must be removed for service, replacement of parts, or replacement of the whole equipment piece. It is noted that these dental equipment pieces or instrument units can be heavy and/or possess geometric dimensions that make them difficult to hold by one person. Removal and fastening of the dental equipment pieces to their support members can be a difficult task. Typically, the weight of the dental equipment piece must be borne entirely by the installer, while screws or other fasteners are attached to the support member. The screws or related fasteners requires that the installer also use tools for installation. Suspending the dental equipment in the air, holding the appropriate installation tools and holding the fastener is a tricky endeavor that difficult for one person to perform. In most cases, the removal and fastening of dental equipment often requires two installers, which is time consuming and inefficient for the dental provider.

### BRIEF DESCRIPTION OF THE DRAWINGS

FIG. 1 shows a side view of a dental equipment connection joint embodiment assembled to a dental support member extending down from a overhead support structure.

FIG. 2 shows a side perspective view of a dental equipment connection joint embodiment in a partially disassembled state.

FIG. 3 shows a side perspective view of a dental equipment connection joint embodiment in a fully disassembled state.

FIG. 4 shows the dental equipment connection joint embodiment illustrated in FIG. 3 from a rotated perspective.

FIG. 5 shows the dental equipment connection joint illustrated in FIGS. 3-4 with certain components being reassembled to show the interaction of components of the joint.

FIG. 6 a-d shows the step-wise operation of the dental equipment connection joint embodiment illustrated in FIG. 1 demonstrating the easy, one-step operation of the joint embodiment.

### DESCRIPTION

The inventors have devised a new way of installing dental equipment to support members in a dental operatory that is quick and easy and does not require more than one installer to perform. The inventions of this application relate to a dental equipment connection joint that enables the facile attachment of a dental equipment piece to a support structure without the need for using hand tools. That is, the installer can readily and easily attach dental equipment, such as a dental light or dental instrument unit, to the dental equipment connection joint solely through the use of hand manipulation, without tools, according to a one-step operation. The inventions enable the replacement of potentially heavy dental equipment via a process that alleviates the need for the installer to bear the load of the equipment while installing a screw or similar fasteners.

One embodiment of the inventions pertain to a dental equipment connection joint for securely fastening and holding a dental equipment piece, the dental equipment connection joint including an elongated mount support member having a distal end and a proximal end with an intermediary body portion. The joint further includes a mount body associated with the distal end of the mount support member, the mount body having a housing defining a receptacle into which an equipment connector member may be inserted and at least one window defined in the housing. The joint includes a mount bracket assembly having a first locking member and a second locking member, the first and second locking members each comprising an outer surface and an inner surface, and at least one spring component, wherein at least the first locking member comprises a projection extending from the bracket inner surface, and wherein the first locking member and the second locking member are urged toward each other by the at least one spring component and held around the mount body so as to at least partially encase the mount body with the first locking member aligned respective to the mount body such that the projection enters the at least one window.

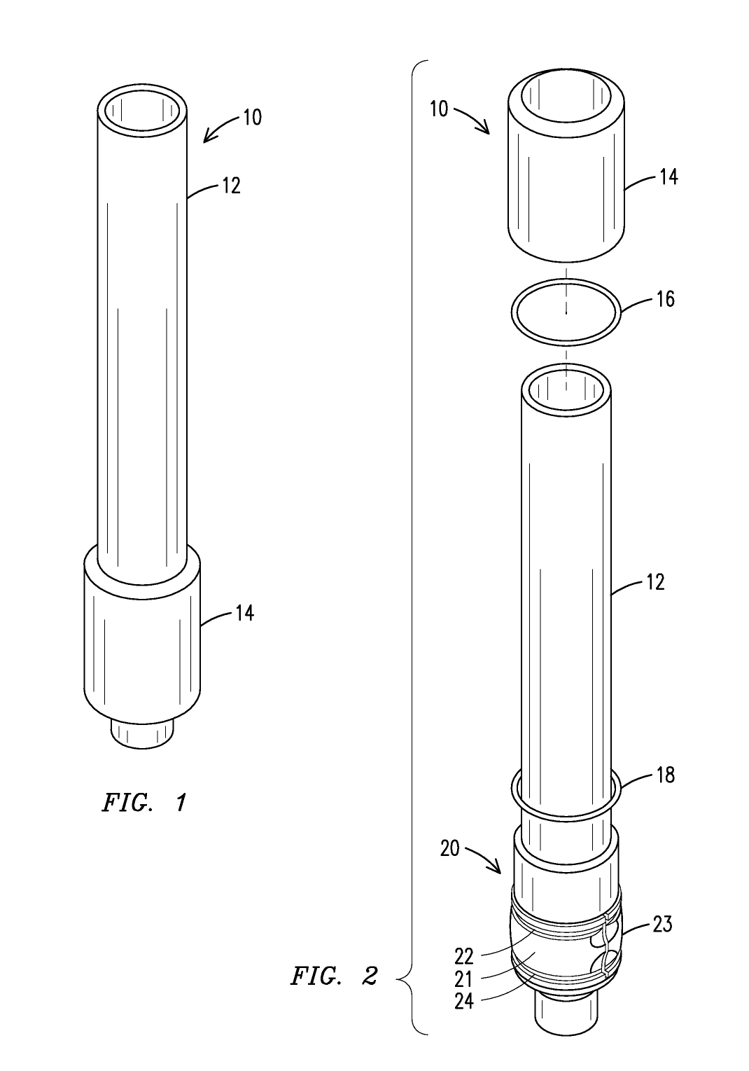

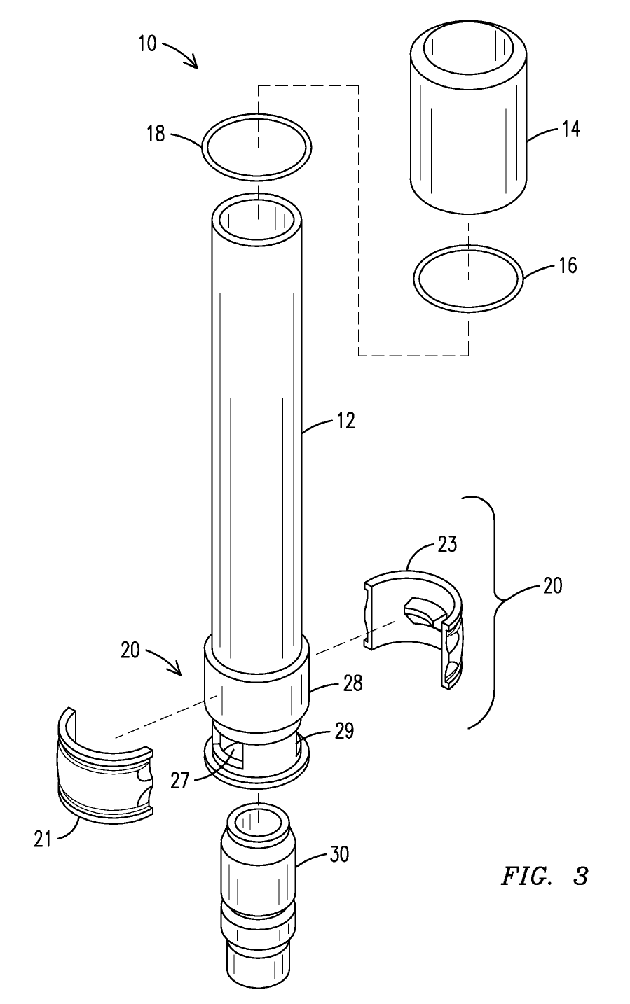

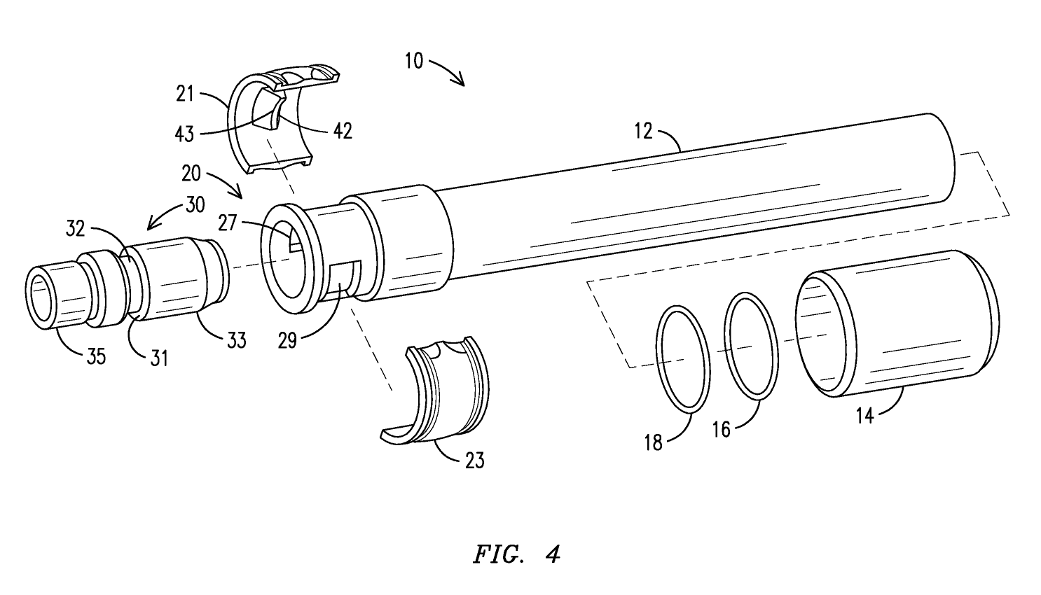

FIG. 1 shows one embodiment of a dental equipment connection joint 10 with a dental equipment support member 12 and a cover sleeve 14. FIG. 2 shows a side perspective view of the embodiment 10 that is partially disassembled. The cover 14 is shown removed as well as elastomeric O-rings 16 and 18 which were resting in grooves 22 and 24, respectively, prior to removal. The mount assembly 20 includes a main mount body (as shown in FIG. 3) a first detachable locking member 21, and second mount bracket mount component 23 which are shown associated with each other in FIG. 2. When positioned in the grooves, the O-rings hold the locking members in position on the support member 12. First and second locking members 21, 23, are shown disassociated in FIG. 3. Turning the discussion to FIG. 3, the cover sleeve 14 and O-rings 16 and 18 have been fully disassociated from the mount support body 12. Mount locking members 21 and 23 are disassociated from each other and the mount body 28 to reveal window 27 and partially window 29. The equipment connector member 30 is also disassociated from the mount assembly 20.

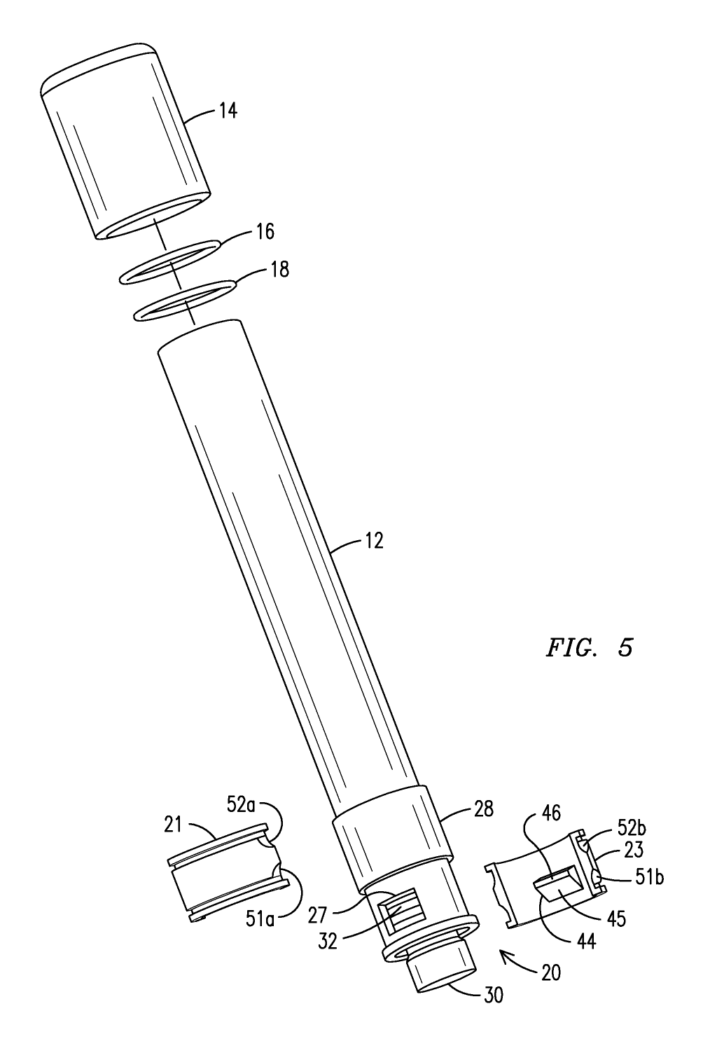

FIG. 4 shows disassembled bracket members 21 and 23 from a different angle to reveal window 29. Shown in FIG. 4 are the different features of the equipment connector member 30. A first end 33 is beveled or otherwise sloped to facilitate entry of the connector member into the mount assembly as will be discussed below. The connector member also includes a groove 32 for interaction with tab 42. A connector member is inserted into the mount assembly. At the end of the connector member 30 opposite end 33 is an equipment piece attachment end 35. This end 35 may take one of numerous configurations that are suitable for attachment to dental instruments known in the art.

FIG. 5 shows a side perspective view of the partially disassembled dental equipment connection joint 10. The connector member 30 is inserted into the mount support 12 and/or mount body 28. Also revealed in FIG. 5 is mount tab 44 associated with mount bracket 23. Window 27 on the mount body 28 through which groove 32 of the connector member 30 is exposed. Locking members 21, 23 are brought together such that tab 42 of mount locking member 21 and tab 44 of mount bracket 23 are positioned to interface with windows 27 and 29, respectively. Tabs 42 and 44 are urged to interface with groove 32 via windows 27 and 29, respectively, with generally radial surface 43 of the tabs engagable with a generally radial surface 31 presented by a recess on the connector member 30 to support a load on the connector member tending to pull it out of the support member 12. Tab 44 includes a leading edge 46 and ramped portion 45. Tab 42 also includes a leading edge and ramped portion.

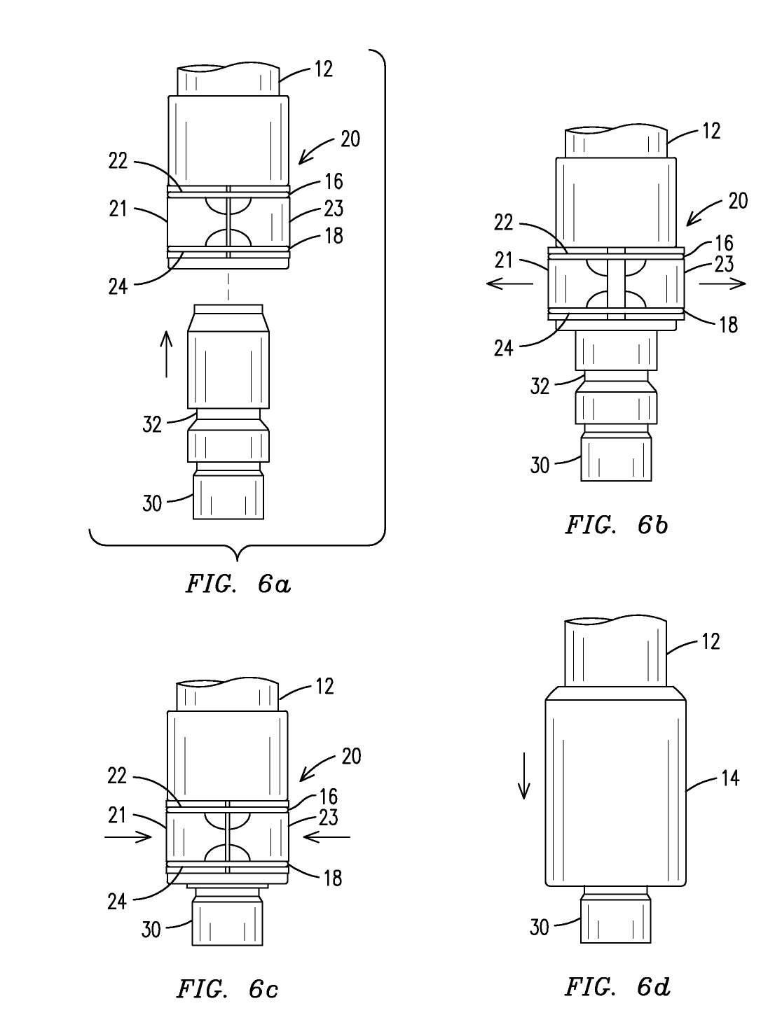

FIGS. 6a-d show the coordination of components 21 and 23 with O-rings 16 and 18 shown in grooves 22 and 24, respectively, as the equipment connector member 30 is inserted into the dental mount assembly 20. The connector member 30 is inserted into the dental mount assembly 20 whereby locking members 21 and 23 are pushed out (see arrows) by interfacing of the connector member 30 against tabs 42, 44. Once the connector member 30 is fully inserted into the mount assembly, tension from the O-rings 16 and 18 urge locking members 21 and 23 back inward, such that tabs 42 and 44 push into groove 32 of the connector member 30. This securely locks the connector member 30 to the mount assembly 20. The cover sleeve 14 is slid down the mount body 12 and over the mount assembly 20.

Turning back to FIG. 5, indentations 51a and 52a on component 21 and indentations 51b and 52 b, the components 21 and 23 are associated together though urging of O-rings 16 and 18. Indentations 51a and 51b and 52a and 52b create an access space to facilitate manipulation of O-rings 16 and 18 when a installer desires to remove the connector member the installer simply needs to remove the cover sleeve 14 and grab the O-rings 16 and 18 with the installer's fingers to remove them from components 21 and 23. Once O-rings 16 and 18 are removed, components 21 and 23 separate to release the connector member 30.

Although the foregoing description contains many specifics, these are not to be construed as limiting the scope of the present inventions, but merely as providing certain representative embodiments. Similarly, other embodiments of the inventions can be devised which do not depart from the spirit or scope of the present inventions. The scope of the inventions is, therefore, indicated and limited only by the respective appended claims and their legal equivalents, rather than by the foregoing description. All additions, deletions, and modifications to the inventions, as disclosed herein, which fall within the meaning and scope of the claims, are encompassed by the present inventions. The disclosures of any references cited herein are incorporated in their entirety to the extent not inconsistent with the teachings herein.

What is claimed is:

1. A dental equipment detachable connection joint for facilitating the installation and/or removal of dental equipment to a dental support member solely through hand manipulation by a single installer, without the need for tools, the connection joint comprising
a connection socket associable with a distal end of the support member, the mount body comprising a housing defining a receptacle into which a movable connector member may be inserted and at least one window defined in the housing; and
a detachable locking assembly comprising a first locking member and a second locking member, the first and second locking members each comprising an outer surface and an inner surface, and at least one spring component, wherein at least the first locking member comprises a projection extending from the bracket inner surface, and wherein the first locking member and the second locking member are biased toward each other and held in a position on the support member so as to at least partially encase the connection socket with the first locking member aligned respective to the connection socket such that the projection moves to a position adjacent to at least one window in the connection socket.

2. The dental equipment connection joint of claim 1, wherein the connection socket comprises a first and second window and wherein the second locking member comprises a projection extending from the second locking member inner surface whereby the projection of the first bracket enters the first window and the projection of the second bracket enters the second window.

3. The dental equipment connection joint of claim 1, further comprises at least one elastic o-ring for biasing one of the locking members to a position at the window.

4. The dental equipment connection joint of claim 3, wherein the first locking member and the second locking member comprise a groove thereof into which the at least one elastic o-ring is situated.

5. The dental equipment connection joint of claim 4, wherein the first locking member and second locking member comprise two or more grooves with an elastic o-ring situated in each groove.

6. The dental equipment connection joint of claim 1 wherein the connector member comprises a proximal end and a distal end and a body portion, the body portion comprising a connector recess.

7. The dental connection joint of claim 6, wherein the connector member is inserted into the connector socket such that the projection of the first locking member is received in the connector member recess via the at least one window.

8. A dental equipment connection joint for facilitating the securing and removal of dental equipment solely through hand manipulation without the need for tools, the dental equipment mount comprising
an elongated mount support member having a distal end and a proximal end with an intermediary body portion;
a mount body associated with the distal end of the mount support member, the mount body comprising a housing defining a receptacle into which a connector member may be inserted and at least one window defined in the housing; and
a mount bracket assembly comprising a first locking member and a second locking member, the first and second locking members each comprising an outer surface and an inner surface, and at least one spring component, wherein at least the first locking member comprises a projection extending from the bracket inner surface, and wherein the first locking member and the second locking member are urged toward each other by the at least one spring component and held around the mount body so as to at least partially encase the mount body with the first locking member aligned respective to the mount body such that the projection moves to a position adjacent to at least one window in the connection socket.

9. The dental equipment connection joint of claim 8, wherein the mount body comprises a first and second window and wherein the second bracket comprises a projection extending from the second bracket inner surface whereby the projection of the first bracket enters the first window and the projection of the second bracket enters the second window.

10. The dental equipment connection joint of claim 8, wherein the at least one spring comprises at least one elastic o-ring.

11. The dental equipment connection joint of claim 8, wherein the first bracket and the second bracket comprise a bracket groove into which the at least one elastic o-ring is situated.
